(19) United States
(12) Patent Application Publication
(10) Pub. No.: US 2008/0134906 A1
(43) Pub. Date: Jun. 12, 2008

(54) FLEXIBLE BAKING STRUCTURE FOR DOUGH PRODUCTS, SYSTEM, AND METHOD OF PREPARING A DOUGH PRODUCT

(76) Inventors: Sashay M. Mattox, Andover, MN (US); John J. Fenske, Shoreview, MN (US)

Correspondence Address: GENERAL MILLS, INC., P.O. BOX 1113, MINNEAPOLIS, MN, 55440, US

(21) Appl. No.: 11/952,347

(22) Filed: Dec. 7, 2007

Related U.S. Application Data
(60) Provisional application No. 60/869,183, filed on Dec. 8, 2006.

(51) Int. Cl. A23P 1/10; A21D 6/00; A23L 1/01

(52) U.S. Cl. 99/440; 426/412; 426/496

(57) ABSTRACT

An apparatus, method, and system for baking individual dough products or a plurality of dough products. A flexible, adjustable baking structure, such as a baking strip, is secured about the perimeter of at least one dough intermediate before baking on a flat pan. The flexible, adjustable baking structure acts as a temporary pan-like edge that allows the dough intermediates to evenly crisp and brown during baking while retaining its shape. The flexible, adjustable baking structure can be packaged along with a plurality of dough products, or packaged separately. The flexible baking strip allows a user to prepare any quantity of dough products on any type of flat, unwalled pan without compromising desired baked characteristics such as shape, visual appearance, taste and/or texture.

### CROSS-REFERENCE TO RELATED APPLICATIONS

This application claims the benefit of priority under 35 U.S.C. 119(e)(1) of a provisional patent application, Ser. No. 60/869,183, filed Dec. 8, 2006, which is incorporated herein by reference in its entirety.

### FIELD OF THE INVENTION

The disclosure is generally directed to baking pans for dough products and related methods for baking dough products. More particularly, the disclosure is directed to a device to allow flexibility in the choice of baking pan or sheet and related methods and systems for preparing selected numbers of dough products while maintaining product shape and baked attributes.

### BACKGROUND OF THE INVENTION

Dough products in either a raw, refrigerated, or frozen state require application of energy, typically heat energy, in preparing a final baked bread having desirable baked product characteristics. Desirable baked product characteristics can include, for example, a golden brown appearance, a crisp outer edge, a moist center, and other similar and related characteristics. Factors influencing the achievement of such characteristics can include dough composition, pre-baking steps, and baking conditions such as pan type, oven temperature, baking time, and other such factors.

Representative commercial ready-to-bake dough products, such as, for example, biscuits, dinner rolls, sweet rolls, and the like, generally come in packages containing multiple servings. The number of servings can be large, such as eight or more servings per package. Typically, multiple servings of dough products, such as an entire package of sweet rolls, are arranged in a pan with sidewalls, such as a cake pan, for baking. The dough products can be arranged in a cluster so that the outer perimeter of the cluster is sufficiently in contact with the sidewalls of the baking pan to ensure crisping on the top surface, while retaining moisture within the dough products. Use of such a baking pan generally results in the baked products baking evenly in height, with each dough product having similar browned and crisped outer surfaces with a moist center.

There can be occasions when a consumer may not want to bake multiple servings or an entire package of dough products at one time. For example, a consumer may desire to bake only one or two servings at a time. If a small serving is prepared, such as a single serving, using the standard method of preparing a final baked product could result in baked products that may have undesirable characteristics due to size limitations associated with the baking pan. For example, one or two dough products placed in a cake pan individually standing alone or as a small cluster generally do not fill the cake pan. The side perimeter of the dough products does not contact either the edge of the pan or other dough products and at least a portion of the outer edge of each dough product or the small cluster is overly exposed. Therefore, one or more of the resulting baked products generally exhibits one or more undesirable characteristics such as, for example, a dry or hard center, uneven browning or no browning at all, loss of symmetry or shape, excessive crisping and loss of center moistness, and the like.

Similarly, undesirable baked products can result if the optimally sized baking pan is not used. For example, if a cluster of dough products are baked on a cookie sheet rather than a pan having a side edge, the resulting baked product can again exhibit undesirable characteristics as described above because the sides of the products in the cluster is excessively exposed to the heat of the oven. In addition, the individual dough products can lose their desired baked product shape because accelerated baking occurs on the exposed sides of products, causing premature setting of the structure. Thus, the unexposed portion continues to rise and expand, while the outer portion does not expand any further.

Another problem can arise when it is desired to prepare larger numbers of baked products, such as, for example, multiple packages of dough products. Baking pans with sides, such as cake pans, are often of insufficient size to bake more than a single package at any one time. Baking each package in series adds additional baking and preparation time. If multiple packages of dough products are placed on a cookie sheet lacking sides to accommodate the cluster size, the resulting products can exhibit undesired characteristics as described above.

As such, it would be advantageous to have a versatile baking aid for use in conjunction with a flat pan for accommodating various portion sizes, both large and small, without compromising baked product quality.

### SUMMARY

The present disclosure is directed to a flexible, length adjustable baking structure to act as a sidewall in close proximity, for selectively accommodating an individual dough product or a plurality of dough products arranged, for example, in a cluster or a row, while retaining and/or improving desirable baked product characteristics, such as, for example, shape, visual appearance, taste, moisture retention, increased bake volume, and texture that would typically be diminished with the use of a flat pan alone. Following the baking of a dough product utilizing the flexible baking aid, the resulting baked dough product is similar and in certain products, improved, in taste and visual appearance as a baked dough product prepared with a traditional baking procedure utilizing traditional bake-ware, such as a pan with side edges.

In one aspect of the present invention, a flexible baking wall comprises an adjustable strip of material that can be wrapped about the perimeter of an individual dough product or a plurality of dough products arranged in a cluster or a row on a pan such that the outer perimeter of the dough product or plurality is in contact with the strip of material. The strip of material acts as a temporary pan edge to aide in retaining a desired shape of the dough product and to ensure browning and crisping of the outer edge of the dough product while maintaining a moist side and center.

In another aspect of the present invention, a method of baking dough products includes selecting a serving size of one or more dough intermediates. Placing the dough intermediates(s) on a flat pan, such as, for example, a cookie sheet. The length of the baking structure is adjusted, either shortened or multiple structures joined in series, so that at least a portion of the perimeter of at least one dough intermediate is in contact with the flexible baking strip. At least one flexible baking structure is wrapped around the outer perimeter of the selected serving size of dough intermediates. The one or more dough intermediates are baked to produce a desirable product with even surface and sidewall browning (or lack thereof) and crisping, evenly unbrowned side portions, and a moist center.

In yet another aspect of the present invention, a system for baking an individual dough product or a plurality of dough products comprises a package of dough intermediates, and one or more disposable flexible baking strips within the package. The one or more baking strips can be used to accommodate the baking of one or more of the dough intermediates to produce a baked dough product without compromising desirable visual, texture, and/or taste, and in certain products, produces improved characteristics, such as increased baked volume and/or moisture retention.

In another aspect of the present invention, a method for simulating baking performance of a walled pan includes providing a flat cooking surface; providing a dough intermediate and baking strip in a dough product package; arranging one or more dough intermediates on the cooking surface; wrapping a flexible baking strip around the one or more dough intermediates; and baking the dough intermediate to produce a desirable product with even browning and crisping, evenly unbrowned side portions, and a moist center.

As used herein, the term “dough intermediate” refers to dough-based products, such as rolls, biscuits, buns, and the like that require a further thermal processing step by the end user prior to consumption.

As used herein, the term “dough product” refers to any of a variety of dough types such as, for example, developed dough and undeveloped dough as well as biscuits, rolls, bread, bread sticks, cookies, croissants, and pizza crust.

As used herein, the term “dough packaging” refers to any of a variety of packaging types such as, for example, a plastic bag, paper bag, box, tube or can, a plastic-wrapped package, metal or metallized container, and the like.

As used herein, the term “baking” refers to the application of dry heat energy by such methods as convection, conduction, and the like, or application of energy by infrared radiation, electromagnetic radiation, such as microwave energy, and the like.

As used herein, the term “pan” refers to any of a variety of bakeware such as, for example, a cookie sheet, cake pan, pie tin, casserole, and the like, regardless of construction material.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is top view of a flexible baking structure according to one embodiment of the invention.

FIG. 2 is a perspective view of a flexible baking structure according to one embodiment of the invention.

FIG. 3 is a side view of a flexible baking structure and dough intermediates according to one embodiment of the invention.

FIG. 4 is a top view of a system for baking a variable number of dough products according to one embodiment of the invention.

FIG. 5 is a top view of a system for baking a variable number of dough products according to one embodiment of the invention.

FIG. 6 is a top view of a desirable result of a dough product baked with a flexible baking structure according to one embodiment of the invention.

FIG. 7 is a perspective view of the prior art of a dough product baked without a flexible baking structure according to one embodiment of the invention.

FIG. 8 is a perspective view of a comparison of a baked dough product baked with a flexible baking structure and a baked dough product baked without a flexible baking structure according to one embodiment of the invention.

FIG. 9 is a top view of a flexible baking structure according to one embodiment of the invention.

FIG. 10 is a top view of a flexible baking structure according to one embodiment of the invention.

FIG. 11 is a top view of a system for baking a variable number of dough products with the flexible baking structure of FIG. 10.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

A flexible baking structure, including the related methods and baking systems of the present disclosure, provide for baking an individual dough intermediate or plurality of dough intermediates arranged, for example, in a cluster or a row, on a flat pan, so as to achieve baked products possessing desirable characteristics such as, for example, evenly browned and crisped upper surfaces, unbrowned sidewalls, moist centers, and acceptable visual appearance and symmetrical shape. The flexible baking structure can be used to bake a selected number of dough intermediates so as to eliminate product waste or reduce baking times for large numbers of baked products.

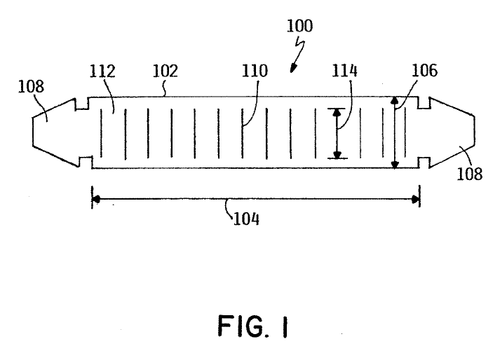

Referring to FIG. 1, a flexible baking structure 100 can comprise an elongated strip 102 of material of length 104 and height 106, and an engagement feature depicted herein as at least one tapered end 108, and a plurality of spaced apart and substantially parallel apertures 110 arranged substantially transverse to a longitudinal axis of strip 102. Strip 102 can comprise length 104 from about 7 to about 20 inches. Strip 102 can comprise a variety of materials suitable for baking including, for example, paper, card stock, wax paper, aluminum foil, as well as other suitable materials and combinations thereof. In one embodiment, strip 102 comprises a paper having a tensile strength of at least about 20 pounds. Strip 102 can optionally comprise a coating 112, such as, for example, a non-stick coating and other such coatings to enhance the baking process and/or finished baked product. In one embodiment, tapered end 108 can be shaped as an arrowhead.

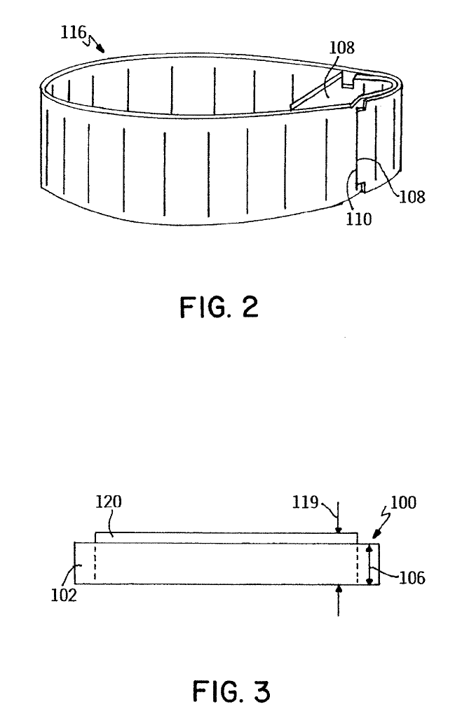

Apertures 110 can be intermittently spaced along substantially strip length 104 of strip 102. Apertures 110 can traverse the longitudinal axis of strip 102 so as to have an aperture length 114 of less than strip height 106 of strip 102. Aperture spacing between each of the plurality of apertures 110 is from about 0.25 inches to about 2.0 inches. As depicted in FIG. 2, at least one tapered end 108 can be adapted to be slidably received within a selected aperture 110 to form a baking ring 116. In one embodiment, tapered end 108 can be received in an aperture 110 of a second strip 118 to link at least two baking structures 100 to form a larger baking ring 116. Second strip 118 preferably comprises a similar construction as elongated strip 102.

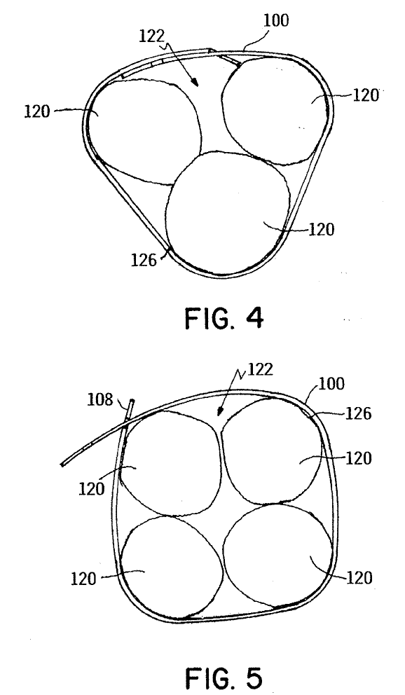

Referring to FIGS. 3, 4, and 5, a method of baking an individual dough intermediates 120 or plurality 122 of dough intermediates can comprise selecting a serving size including one or more dough intermediates 120, and arranging the dough intermediate(s) 120, for example, in a cluster or a row, on a pan 124, such as a cookie sheet. At least one flexible baking structure 100 can be adjusted around outer perimeter 126 of dough intermediate 120 or plurality 122 so that at least a portion of perimeter 126 of at least one dough intermediate 120 is in contact with baking strip 102. As depicted in FIG. 3, a flexible baking structure 100 is secured around an individual dough intermediate 120. As depicted in FIG. 4, a plurality 122 of three dough intermediates 120 are arranged in a cluster with at least one flexible baking structure 100 secured around perimeter 126. As depicted in FIG. 5, a plurality 122 of four dough intermediates 120 are arranged in a cluster with at least one flexible baking structure 100 secured around perimeter 126. More or less dough intermediates 120 can be arranged in any configuration, such as, for example, in a row or a cluster. In one embodiment, a plurality 122 of individual dough intermediates 120 can be arranged without using a cluster configuration. A baking structure 100 can be fitted around each individual dough intermediate 120.

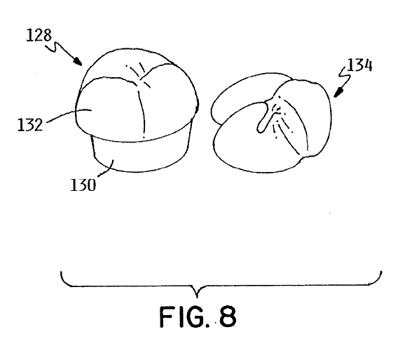

Referring to FIGS. 3 and 8, strip 102 can comprise a height 106 of about 50% to about 150% of height 119 of a dough intermediate 120. Flexible baking structure 100 generally maintains the shape of at least a base portion 130 of dough intermediate 120 during the baking process. For example, a shorter strip 102 is desirable for a dinner roll or biscuit type dough intermediate 120. If height 106 of strip 102 is approximately 50% of height 119, a top portion 132 of dough intermediate 120 is allowed to “puff” out over strip 102, while strip 102 maintains the shape of base portion 130 of dough intermediate 120.

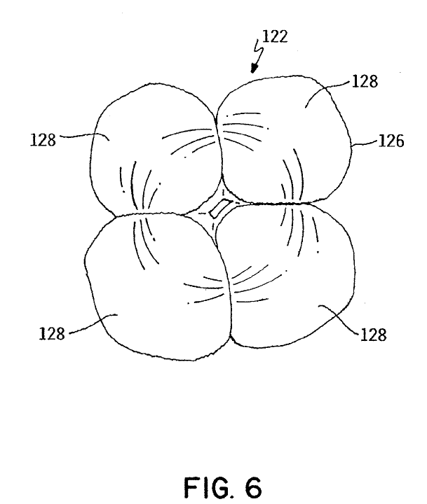

Plurality 122 and/or one or more individual dough intermediates 120 are baked at standard time and temperatures as if an entire package of dough products 128 is prepared. Baking structure 100 is removed and either disposed of or saved to be used additional times. As depicted in FIG. 6, baked dough product 128 exhibits desirable visual, texture, and taste characteristics, such as, for example, even browning and crisping, a moist center, and desired shape, similar to baked products baked according to standard baking methods. In some instances, baked dough product 128 exhibits improved baked characteristics, such as, for example, improved moisture retention, increased baked volume, and the like, over baked products baked according to standard baking methods.

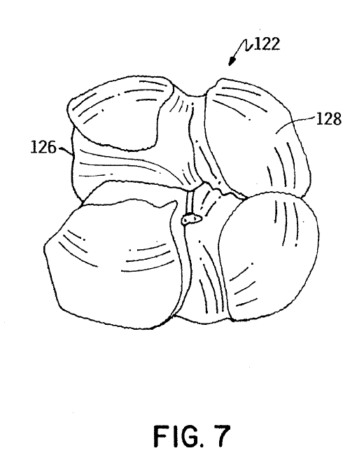

Individual dough intermediates or a small plurality 122 of dough intermediates 120 are often baked on a pan 124, such as a cookie sheet, with no raised edge, or in a pan 124 that is larger in area than plurality 122. Outer perimeter 126 of plurality 122 has no contact with an edge or wall of a pan and is completely exposed to the environment of an oven during baking. As a result, dough products 128 exhibit undesirable characteristics, such as uneven browning or crisping, excessive drying on the product side portions, due to overexposure to heat on one side, and loss of a defined baked shape, as illustrated in FIG. 7.

Referring to the illustrative example shown in FIG. 8, an individual baked dough product 128 baked using baking structure 100 retains the shape of base portion 130 while allowing top portion 132 to protrude over strip 102. On the other hand, baked dough product 134 baked without using a baking structure 100 bakes into an asymmetrical and unsightly shape.

One or more baking structures 100 can be packaged with dough intermediates 120 to create a system for baking individual dough products or a cluster of dough products. In one embodiment, the ratio of baking strips to dough products can be 1:1. In an alternative embodiment, baking structure 100 can be sold separately from dough intermediates 120. Baking structures 100 can be sold individually, or as a group, such as a wound roll of baking structures 100.

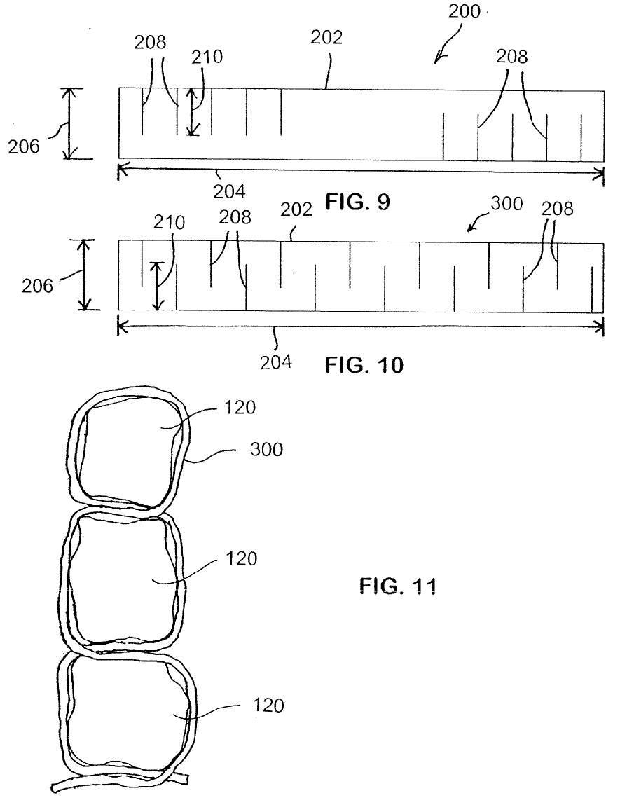

Another representative embodiment of a flexible baking structure 200 is illustrated in FIG. 9. Flexible baking structure 200 can comprise an elongated strip 202 of material having a strip length 204 and strip height 206, and an engagement feature depicted herein as a plurality of spaced apart slits 208 arranged substantially transverse to a longitudinal axis of strip 202. Strip 202 can comprise length 204 from about 7 to about 20 inches. Strip 202 can comprise a variety of materials suitable for baking including, for example, paper, card stock, wax paper, aluminum foil, as well as other suitable materials and combinations thereof. In one embodiment, strip 202 comprises a paper having a tensile strength of at least about 20 pounds. Strip 202 can optionally comprise a coating such as, for example, a non-stick coating and other such coatings to enhance the baking process and/or finished baked product.

Slits 208 can be intermittently spaced along strip length 204 of strip 202. Slits 208 generally traverse the longitudinal axis of strip 102 so as to have a slit length 210 less than strip height 206. Slit spacing between each of the plurality of slits 208 can be from about 0.25 inches to about 2.0 inches. As illustrated in FIG. 9, slits 208 are arranged on opposed sides of the strip 202 so as to promote interlocking of the ends of the strip 202. Slits 208 can operably link multiple strips 202 to form a larger baking ring.

In an alternative configuration shown in FIG. 10, a flexible baking structure 300 can substantially resembly flexible baking structure 200 with the exception of slits 208 being arranged in an alternating, opposed configuration. In this manner, flexible baking structure 300 can be wrapped over itself as illustrated in FIG. 11 so as to individually isolate a plurality of dough intermediates 120 during baking.

The flexible baking structure, method of using the flexible baking structure to prepare a dough product, and the system for baking individual dough products or a plurality of dough products provide the option of baking one or more dough products in conjunction with any flat pan, without compromising desirable baked product characteristics such as taste, texture, and shape.

The invention may be embodied in other specific forms without departing from the essential attributes thereof; therefore, the illustrated embodiments should be considered in all respects as illustrative and not restrictive. The claims provided herein are to ensure adequacy of the present application for establishing foreign priority and for no other purpose.

What is claimed:

1. A flexible baking structure for baking individual dough products or a plurality of dough products on a flat surface, the flexible baking structure comprising:
a strip of material having an engagement feature adapted to selectively define a baking ring with the strip of material, wherein the baking ring can be positioned about the perimeter of at least one dough product to provide a temporary pan edge to attain desirable baked characteristics.

2. The flexible baking structure according to claim 1, wherein a strip height is from about 50% to about 150% of a dough product height enclosed by the baking ring prior to baking.

3. The flexible baking structure according to claim 1, wherein the strip of material is selected from the group consisting of: paper, card stock, foil, wax paper, and combinations thereof.

4. The flexible baking structure according to claim 1, wherein the strip of material is a paper comprising a tensile strength of at least about 20 pounds.

5. The flexible baking structure according to claim 1, wherein the strip of material has a strip length from about 7 to about 20 inches.

6. The flexible baking structure according to claim 1, wherein the engagement feature comprises a plurality of spaced apart apertures arranged along a longitudinal axis of the strip of material and a tapered end at each end of the strip of material. an aperture spacing between each of the plurality of apertures is from about 0.25 inches to about 2.0 inches.

7. The flexible baking structure according to claim 6, wherein the apertures have an aperture spacing from about 0.25 inches to about 2.0 inches.between each of the spaced apart apertures.

8. The flexible baking structure according to claim 6, wherein each tapered end is shaped as an arrowhead.

9. The flexible baking structure according to claim 1, wherein the engagement feature is selected from the group comprising: slits, apertures and tapered ends.

10. A method for preparing various quantities of dough products using at least one flexible, adjustable baking strip, the method comprising the steps of:
selecting a serving size including at least one dough intermediate;
arranging the at least one dough intermediate on a pan;
securing at least one flexible baking structure about a perimeter of the at least one dough intermediate wherein the baking structure is in contact with at least a portion of the perimeter of the at least one dough intermediate; and
baking the at least one dough intermediate to produce at least one baked product;
wherein the baking structure enables the at least one baked product to exhibit desirable baked characteristics.

11. The method according to claim 10, wherein the desirable baked characteristics can include even browning, crisping, shape retention, moist interior, and combinations thereof.

12. The method according to claim 10, wherein the dough intermediate is selected from the group consisting of: biscuits, dinner rolls, sweet rolls, and combinations thereof.

13. The method according to claim 10, wherein the at least one flexible baking structure comprises an elongated strip of material having a plurality of spaced apart apertures traversing the strip, and at least one tapered end, such that the at least one tapered end is adapted to be received within a selected aperture.

14. The method according to claim 13, wherein the flexible baking structure is selected from the group consisting of paper, card stock, foil, wax paper, and combinations thereof.

15. The method according to claim 10, further comprising: disposing of the flexible baking structure after baking the at least one dough intermediate.

16. A method for simulating the baking performance of a walled pan comprising:
providing a baking strip;
positioning a dough intermediate on a cooking surface;
wrapping the baking strip around the dough intermediate; and
baking the dough intermediate.

17. The method according to claim 16, wherein the baking strip and the dough intermediate are provided together in a dough product package.

18. The method according to claim 17, wherein the ratio of flexible baking structures to dough intermediates is 1:1.

19. The method according to claim 16, wherein the dough intermediate is selected from the group consisting of biscuits, dinner rolls, sweet rolls, and combinations thereof.

20. The method according to claim 16, wherein the at least one flexible baking structure comprises an elongated strip of material having a plurality of spaced apart and substantially parallel apertures traversing the strip, the elongated strip having and at least one tapered end such that the at least one tapered in is adapted to be received within a selected aperture.
